(19) United States
(12) Patent Application Publication
(10) Pub. No.: US 2020/0270860 A1
(43) Pub. Date: Aug. 27, 2020

(54) SOUND-ABSORBING ROOF CONSTRUCTION OF A HALL HAVING REDUCED REVERBERATION TIME

(71) Applicant: LIAVER GMBH & CO.KG, llmenau (DE)

(72) Inventors: Christian HOPPE, Erfurt (DE); Elmar Johannes Anton TOBER, Wuerzburg (DE); Ronald TSCHIERSCH, Stuetzerbach (DE)

(21) Appl. No.: 16/762,984

(22) PCT Filed: Nov. 8, 2018
(86) PCT No.: PCT/EP2018/080632

§ 371 Date: May 11, 2020

(30) Foreign Application Priority Data
Nov. 11, 2017 (DE) 10 2017 126 506.6

(51) Int. Cl. E04B 1/86; E04C 3/29; G10K 11/162

(52) U.S. Cl. CPC E04B 1/86; E04B 9/001; G10K 11/162; E04C 3/29

(57) ABSTRACT

The invention relates to a sound-absorbing roof construction of a hall (01) with walls (02), several roof trusses (03) resting at least at their ends on the walls (02) and with a sound-reflecting roof cladding (06) carried by the roof trusses (03). On the side faces of several of the roof trusses (03) there are absorber strips (04) which are composed of sound absorber elements. A sound-reflecting section of the roof cladding (06) extends between adjacent roof trusses (03) with the absorber strips (04) with a width that is at least twice the average height of the roof trusses (03).

The invention also relates to a sound absorber arrangement with sound absorber elements which are arranged in a hall (01) with walls (02) and a roof structure which closes the hall upwards, the roof structure comprising a plurality of roof trusses (03) and a roof cladding (06) carried by them.

According to the invention, absorber strips (04) are attached to the two side surfaces of several of the roof trusses (03), which are composed of sound absorber elements arranged in a row.

Finally, the invention relates to a hall (01) with reduced reverberation time, which uses the sound absorber arrangement.

### BACKGROUND OF THE INVENTION

The present invention relates to a sound-absorbing roof construction of a hall and a sound absorber arrangement and a hall with reduced reverberation time, using sound absorber elements and sound-absorbing absorber strips made from such elements.

Sound-absorbing elements to improve room acoustics, i.e. for better speech intelligibility and for hearing protection, have long been known. Acoustic ceilings made of plasterboard or fiberboard improve the room acoustics, reduce the reverberation and convert sound energy into heat. Acoustic wall claddings are also known, for example panels which are attached to the walls in different angles and sizes and serve as depth absorbers for absorbing low sound frequencies. For the absorption of high sound frequencies, the use of perforated plates is customary, which are attached to the wall at certain distances. There are sound-absorbing and sound-absorbing materials, such as foams or felts, between the panels and the wall.

DE 10 2011 105 608 A1 shows a sound absorber arrangement in the manner of an edge absorber for low frequencies. The arrangement includes trough-shaped, preferably cuboid-shaped containers with fibrous or porous absorption material located therein, which have a soundproof or sound-permeable covering. The containers are arranged in the corners or edges of a room on the wall or ceiling. The sound absorber arrangement is distinguished by the fact that all sides facing the room are designed to be soundproof. Only a side that is arranged obliquely, preferably perpendicular to a wall or the ceiling, is designed to be absorbent with a smaller area. In order to achieve the desired effect, the containers used must have a minimum size, for which a corresponding space must be provided locally. A preferred embodiment uses, for example, a 400 mm×500 mm thick, homogeneous fibrous absorber, which is arranged on the floor near a room edge.

DE 10 2015 109 808 A1 describes a sound-absorbing component, in particular for outdoor use, comprising a sound-absorbing cover layer and sound absorber elements embedded therein with an increased degree of absorption compared to the cover layer.

EP 2 868 826 A1 describes a reinforced concrete element, on the surface of which a partially exposed, sound-absorbing, at least partially open-celled foamed material is arranged. The reinforcement is partially enclosed by the foamed material. A ceiling element is also shown, which has several absorber strips made of geopolymer. If the concrete element is used as a ceiling slab, the absorber strips used run lengthways but not in the corner areas between the wall and the ceiling.

Sound absorber elements made of sintered expanded glass granulate are available on the market, as is supplied, for example, by Liaver GmbH & Co. KG under the brand name Reapor.

A product specification sheet from ABC Akustik GmbH, Berlin, from 2011, describes a room acoustic solution for retrofitting in rooms up to 20 m² of floor space and 60 m³ of room volume, whereby the opposite sides of the room should not be more than 5 m apart. For this purpose, absorbers made of open-cell foam based on melamine resin are attached in the form of a stucco edge in the upper edges of the room between the ceiling and the wall. The absorbers protrude approx. 14 to 35 cm into the room so that there is an air space on the back between the absorber and the building wall. The absorbers must be attached to the ceiling with special hangers.

DE 200 22 685 U1describes an acoustically absorptive plate element for eliminating reflected sound in rooms, which can be designed as a suspended ceiling or facing wall.

WO 95/30804 A1 describes a sound absorption system for interior walls and ceilings. Sound-absorbing elements are attached to the ceiling, for example, and extend to the wall. An arrangement is also shown in which corresponding elements are arranged both on the ceiling and on the wall.

Most of the previously known, efficient-acting sound absorber solutions either have to be installed in the rooms to be acoustically improved right from the start or have to be retrofitted with considerable effort. Often there is a conflict of goals between the acoustic effects and the other design of the room from a functional, constructional and design point of view. For example, good acoustic effects can be achieved by completely covering the ceiling with sound absorber panels, but then an arrangement of ceiling air conditioning elements is no longer possible. The retrofitting of sound-absorbing ceilings in existing rooms is structurally and financially complex, so that it is rarely used. The arrangement of large-volume edge absorbers mostly disturbs the aesthetic sense of space considerably.

A sound absorber arrangement consisting of several sound absorber elements is known from patent application PCT/EP2017/061524, which was still unpublished as of the priority date. Several adjacent sound absorber elements form one or more absorber strips which extend at least in sections along an upper abutting edge running between the wall and ceiling of the room.

(Subsequent) noise protection measures in larger properties, such as industrial halls or sports halls, prove to be particularly problematic and complex. There too, strict noise protection requirements exist today. For example, reference is made to: Noise protection worksheet IFA-LSA 01-234, Room Acoustics in Industrial Work Areas, August 2014.

Due to the large volume of the space, absorbers attached to the walls of industrial halls usually cause little sound absorption in the hall area. In addition, only a few or no absorber elements can be attached to the walls, since these surfaces are required for other purposes. Especially in industrial halls, there are regularly very hard floors and hardly any sound absorbing devices, so that the noise levels when using machines or processing hard materials are very quickly in hearing-impairing ranges. In most cases, however, only individual hearing protectors can be used, but they are uncomfortable and make communication between people in such industrial halls more difficult. If one applies the relevant noise protection requirements, this leads to very large absorber areas in the prior art, which are either not feasible or very expensive.

DE 2 347 136 A shows a self-supporting roof element for buildings, which rests with its two ends on a wall and can be used in particular for halls. The roof element has horizontal, longitudinally extending profile flanges which are arranged symmetrically in pairs with respect to a vertical plane of symmetry. The flanges are connected by a framework structure. In order to achieve thermal or acoustic insulation, the inside can be covered with a mat by the framework. Since the surfaces to be covered with insulation material extend at an obtuse angle to the horizontally running outer roof cladding, the resulting insulated surface is significantly larger than the projected surface of the roof cladding. This follows the usual assumption that large areas must be covered with the insulation material for effective insulation or insulation, but this also leads to high costs.

### SUMMARY OF THE INVENTION

The object of the present invention is therefore, based on the prior art, to provide an improved sound-absorbing roof structure and a sound absorber arrangement for larger halls (500-50,000 m³ volume), in particular industrial halls. The sound absorber arrangement used should not impair the original use of the hall, in particular it should not occupy any area or occupy only a small wall area. At the same time, a large absorption effect is to be achieved with a small amount of material, so that the costs, in particular for subsequent soundproofing of the hall, remain low despite the large hall area and volume. A significant improvement in hall acoustics is to be achieved in a wide frequency range. At the same time, the sound-absorbing roof construction should allow the desired absorption results to be achieved in halls with an almost unlimited floor area.

A sound-absorbing roof construction according to the appended claim 1 and a sound absorber arrangement according to claim 13 are used to achieve the object. The object is further achieved by a hall with reduced reverberation time according to claim 14.

The sound-absorbing roof construction according to the invention is a structural component of a hall with walls, a plurality of roof trusses resting at least at their ends on the walls and with a sound-reflecting roof cladding carried by the roof trusses. On the side surfaces of several or all roof trusses, absorber strips are attached, which are composed of sound absorber elements. Between adjacent roof trusses with the absorber strips, a sound-reflecting section of the roof cladding extends with a width that is at least twice the average height of the roof trusses.

The sound absorber arrangement according to the invention comprises a plurality of sound absorber elements which are arranged in a hall with walls and a roof structure which closes the hall upwards. The roof structure has several roof trusses resting on the walls and a roof cladding supported by the roof trusses. According to the invention, absorber strips are attached to both side surfaces of several or all of the roof trusses, which are composed of sound absorber elements arranged in a row. The roof trusses are regularly more than twice, preferably more than four times, their average height apart from one another, so that the area occupied by the absorber strips is in any case smaller than the projected area of the roof cladding. For the functioning of the sound absorber arrangement, it is of crucial importance that between the side surfaces of the roof trusses covered with absorber strips there is a reflecting surface which extends at an angle, preferably at right angles, to the absorber strips and which is formed by the roof cladding not covered with absorber.

Surprisingly, it has been shown that the attachment of absorber elements to the side surfaces of the roof trusses alone leads to considerable sound absorption, which would otherwise only be possible with a significantly larger area use. The side surfaces of the roof trusses are usually not required for other installations in halls, so that they are available for the absorber elements. The volume inside the roof structure is mostly completely unused in industrial halls.

According to the invention, the regularly reverberant and therefore acoustically strongly reflecting inside of the roof cladding acts as a further reflection surface, which reflects the sound waves generated in the interior of the hall to the absorber elements, so that they experience damping there or are possibly completely absorbed.

The roof trusses can have different constructions. It is only important for the invention that they provide two side surfaces on which the absorber strips can be arranged. As a rule, the adjacent roof trusses are spaced several meters apart, preferably 4-8 m, in particular approximately 5-6 m. The interior of the roof construction extends from the lower edge of the roof truss, which is usually formed by a lower flange, to the inside of the roof cladding, which rests on an upper flange of the roof truss. Typically, the lower flange and the upper flange run at an angle to each other, so that the side surfaces of the roof truss have a trapezoidal or triangular shape. The roof trusses have a height of between 300-1,500 mm for the relevant applications. Roof trusses with parallel or approximately parallel upper and lower flanges are also referred to as girders or truss girders. A beam-like or a sheet-like infill can be arranged between the upper and lower flange. The ends of the roof truss lie on the walls of the hall and can be additionally supported if necessary.

According to a preferred embodiment of the sound-absorbing roof construction or the sound absorber arrangement, the absorber strips cover the side surfaces of the roof trusses essentially completely, possibly with the upper and lower flanges being left free. The absorber strip preferably has a width in the range from 400 to 1500 mm and thus follows the height of the roof trusses. The absorber strips can be attached to the upper and lower flanges, for example, using simple metal profiles. Gluing or other fastening of the sound absorber panels is also possible.

In a further development of the sound-absorbing roof construction or the sound absorber arrangement, further absorber strips are used which run along the upper edge of the walls and/or between adjacent roof trusses perpendicular to the side surfaces of the roof trusses in the roof construction. These further absorber strips cover only a small part of the roof cladding between the roof trusses, in particular less than a quarter of the roof cladding area.

A particularly preferred embodiment of the sound-absorbing roof construction or the sound absorber arrangement is characterized in that a reflection surface is arranged between the absorber strips lying opposite one another on the roof truss, which extends between the upper flange and the lower flange of the roof truss. This reflection surface can be an integral part of the roof truss or can be used as a separate component. When sound waves occur, they first pass through the sound absorber element and experience damping, emerge at the rear, then hit the reflection surface—preferably after passing through an air gap—and are thereby reflected back to the sound absorber element in order to be dampened there again.

The sound absorber elements preferably have a thickness of 20-65 mm, particularly preferably about 25 mm. It is also advantageous if the sound absorber elements have a length-specific flow resistance in the range 7-15, preferably 8-12, particularly preferably approximately 10 kPa*s/m⁴.

In preferred embodiments, the sound absorber elements consist of a non-ductile foam, in particular of a glass-based, acoustically effective and permeable foam which comprises expanded glass granulate. The sound absorber elements are preferably made of expanded glass granulate with a grain size of 0.25-4 mm, the granulate being sintered in plate form or connected with added binder, and the length-specific flow resistance preferably being in the range 9-11 kPa*s/m⁴. The preferred length-specific flow resistance of the sound absorber element can easily be set by the grain size used, i.e. the grain size distribution in the preferably plate-shaped sound absorber element and/or by the proportion of binder which is added to the expanded gas granulate during manufacture.

The material used for the absorber strip is expediently suitable for damp rooms, frost-proof, non-flammable and very light. It can also be easily cut to size. Due to the low weight, there are no static problems on the roof trusses, as these are usually designed for installation loads of approx. 25-30 kg/m².

It is advantageous for the functionality of the invention that the sound absorber elements have a length-specific flow resistance in the range 7-15 kPa*s/m⁴, preferably 9-11 kPa*s/m⁴, the flow resistance in the sound absorber elements should be as uniform as possible.

The hall according to the invention with reduced reverberation time can serve different purposes, in particular can be used as an industrial or workshop hall, sports hall or indoor swimming pool. It has walls and a roof structure, the roof structure comprising a plurality of roof trusses resting on the walls and a roof cladding supported by the roof trusses. The previously described sound absorber arrangement is arranged on several or all roof trusses.

A significant advantage of the hall realized according to the invention with reduced reverberation time is that a particularly high absorption of sound can be achieved by arranging the absorber strip on the roof trusses. This high absorption effect is achieved among other things by the reflections of the sound waves occurring in this area on the inner cladding of the roof. The sound absorber arrangement can be retrofitted into existing halls with little effort and requires little installation space in the regularly unused roof space. By arranging the absorber strip on the roof trusses, the areas and volumes available for other uses in the hall are not or only minimally restricted.

The inventive use of sound absorber elements on the side surfaces of the roof trusses makes it possible for the first time to achieve very efficient sound absorption with only small volumes of the sound-absorbing material and the area occupied by the sound absorber arrangement in a wide frequency range. In particular, relatively thin sound absorber elements can be attached in the immediate vicinity of the acoustically highly reflective roof cladding. For this particularly efficient absorption, it is expedient that the length-specific flow resistance is set in the range mentioned, for example, by suitable selection of the grain size and the material composition of the sound absorber elements used. Particularly preferably, the sound absorber elements consist of expanded glass granules with a grain size of 0.25-4 mm, the granules being sintered in plate form or bonded with added binder.

The invention thus also uses a combination of the stated nature of the sound absorber elements and their arrangement in the hall.

According to a particularly preferred embodiment, further absorber strips extend at the upper ends of the walls of the hall.

There are no specific size restrictions for the hall with reduced reverberation time, since the application of the sound absorber arrangement can be scaled as required due to the correspondingly increasing number of roof trusses.

With the sound absorber arrangement used according to the invention, reverberation times in the range of 0.6-1.3 s can be achieved in halls, which corresponds to the desired value in communication rooms. The sound absorber arrangement is particularly suitable for damping in the frequency range from 250 Hz to 4 kHz.

### BRIEF DESCRIPTION OF THE DRAWINGS

Further details and advantages of the sound absorber arrangement according to the invention and the hall equipped therewith result from the following description of a preferred embodiment with reference to the drawing. Shown are:

FIG. 1 is a not-to-scale ceiling view of a first embodiment of a hall according to the invention with reduced reverberation time;

FIG. 2 is a schematic diagram of the sound wave course on a roof cladding and an absorber strip which is attached to a roof truss;

FIG. 3 is a not-to-scale ceiling view of a second embodiment of a hall with reduced reverberation time;

FIG. 4 is a detailed view of the arrangement of the absorber strip on the roof truss in two subsequently attached embodiments;

FIG. 5 is a detailed view of the arrangement of the absorber strip on the roof truss in two integrated embodiments;

FIG. 6 is a diagram to show measured values of the reverberation time in differently configured halls over a wide frequency range.

### DETAILED DESCRIPTION OF THE INVENTION

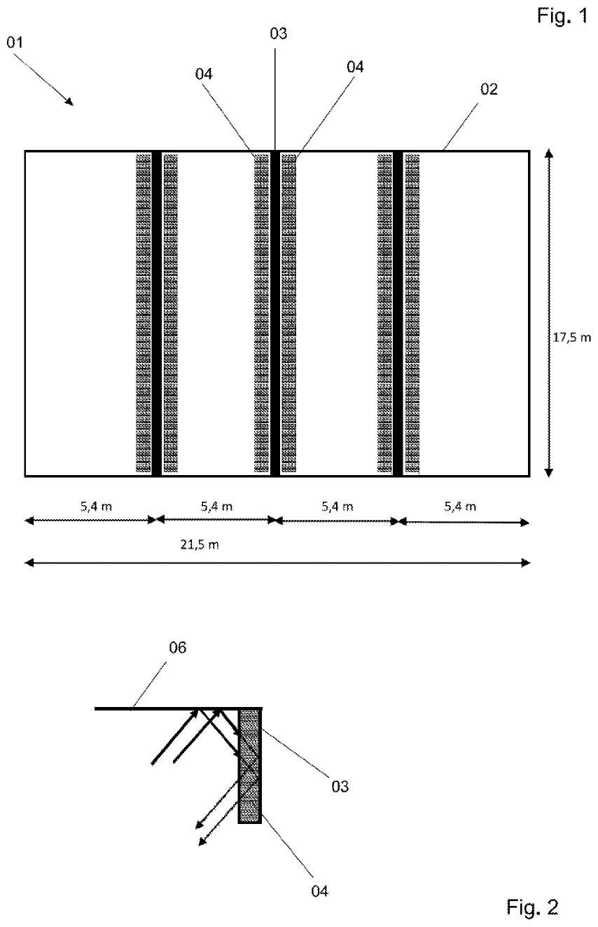

FIG. 1 shows a not-to-scale ceiling view of a hall 01 according to the invention with reduced reverberation time. The floor area of the hall extends, for example, to 21.5 m ×17.5 m. The hall is equipped with a sound absorber arrangement according to the invention, which is designed as a sound-absorbing roof structure. Hall 01 has walls 02 and three interior roof trusses 03, which carry a roof cladding 06 (FIG. 2). Absorber strips 04 are attached to the side surfaces of the roof trusses 03 and essentially cover the entire side surfaces. The roof trusses covered on both sides with absorber strips are spaced about 5.4 m apart in the example shown. There is approximately the same distance between the end walls and the next roof truss. Between the roof trusses 03, sections of the roof cladding 06 extend that are sound-resistant and whose width is more than twice the average height of the roof trusses.

Each absorber strip 04 consists of one or, preferably, a plurality of sound absorber elements made of a non-ductile foam, preferably a glass-based foam with a proportion of expanded glass granulate. This material is well suited for sound insulation and is easy to process. The sound absorber elements have, for example, an absorption coefficient of α=0.4.

The absorber strip has a width that is adapted to the height of the roof truss and a thickness of, for example, 25 mm. The absorber strip 04 is preferably plate-shaped. To form an absorber strip, several sound absorber elements are strung together with little or no space between. Small distances between the sound absorber elements have a marginal effect on the acoustic damping result.

FIG. 2 shows in simplified form the absorber strip 04 arranged on the roof truss 03. It can be seen that the roof cladding 06 rests on the roof truss 03 and the absorber strip covers the side surface of the roof truss essentially in its entire height. The reflections of diffuse sound waves occurring on the roof cladding 06 are shown in a very simplified manner by means of arrows. The incident sound waves are reflected on the roof cladding and directed into the absorber strips, whereby a particularly good absorption effect is achieved by means of the absorber strips 04.

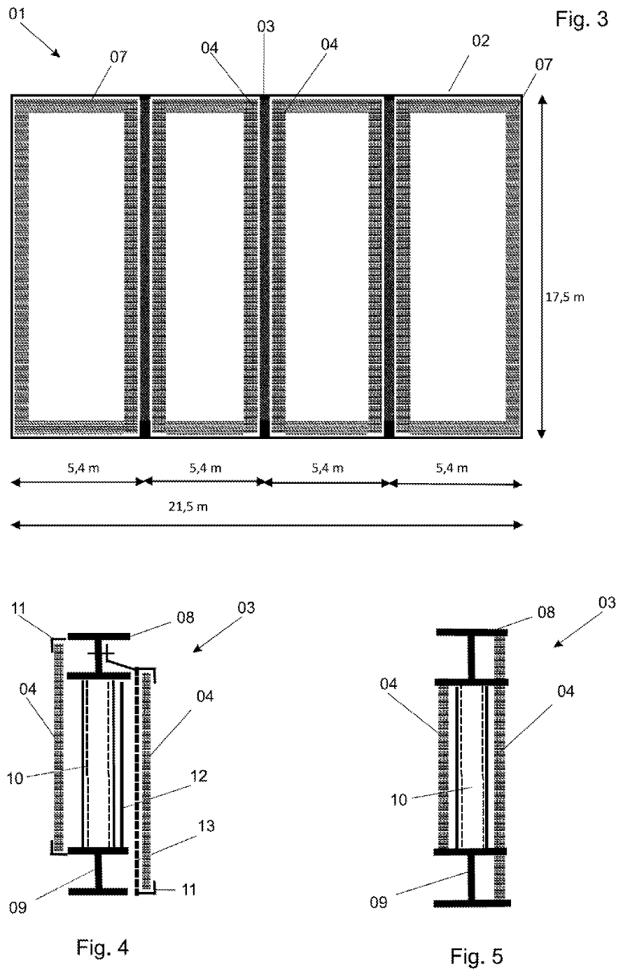

FIG. 3 shows a not-to-scale ceiling view of a second embodiment of Hall 01 with reduced reverberation time. The floor area of the hall is again 21.5 m×17.5 m. In addition to the three inner roof trusses 03, further absorber strips 07 are arranged here at the upper ends of the end walls and on the side walls between the roof trusses.

FIG. 4 shows a simplified cross-sectional view of the roof truss 03, which has an upper flange 08, a lower flange 09 and a stiffening framework 10 between them. In this case, retaining profiles 11 are attached to the roof truss for fastening the absorber strips 04. On the left side of the figure, the absorber strip is held between an upper and a lower holding profile 11, which are each fastened to the upper and lower flange. As shown on the right-hand side of the figure, a holding profile 11 can alternatively be used, which is only attached to the upper flange 08 and yet engages around the absorber strip on its upper edge and lower edge. In this case, the holding profile 11 has a sound-open rear side 13. In preferred embodiments, between the two absorber strips 04 located opposite one another on the roof truss and which are sound-open on the rear, there is a sound-reflecting reflection wall 12 which is positioned between the side surface of the roof truss and the absorber strip in order to return the sound waves penetrating the absorber strips back into the absorber strips. An air gap preferably remains between the absorber strip and the reflection wall 12, which leads to a further diffraction of the sound waves, which has a positive influence on absorption due to interference and impedances that occur.

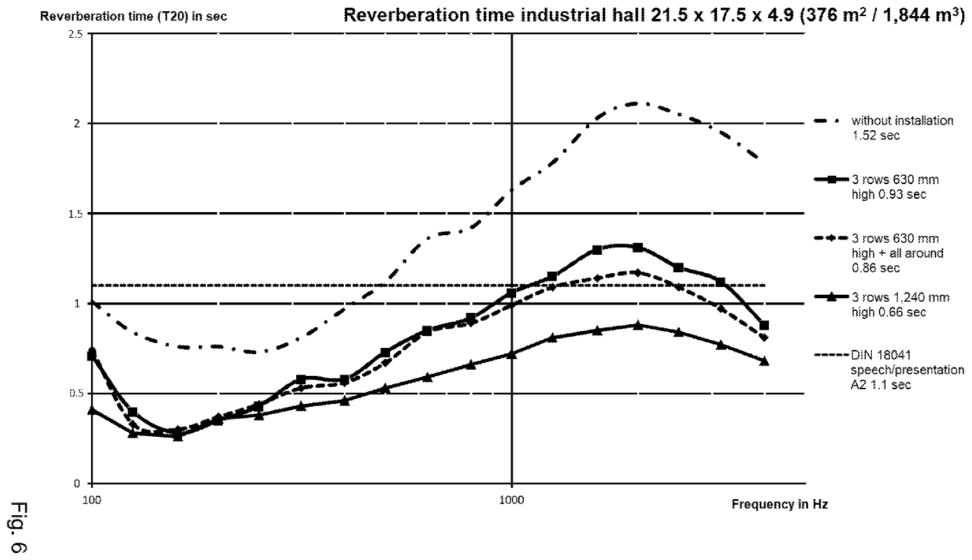

FIG. 5 shows two further design options for the arrangement of the absorber strips 04 on the roof truss 03. These variants are particularly suitable if the absorber strips are not attached to the roof trusses only after the hall has been completed, but the sound-absorbing equipment of the roof trusses is already carried out during the construction phase, preferably already during the manufacture of the roof trusses. For this purpose, the absorber strips 04 are preferably integrated into the roof trusses 03. The absorber strip is inserted between the upper flange 08 and the lower flange 09 on the left-hand side of the illustration in FIG. 5, so that holding profiles can be dispensed with. The absorber strip can either be attached to the supporting structure 10 and/or to the upper and lower flange. On the right side of the illustration, a first section of the absorber strip 04 is again arranged between the upper and lower flange, while further sections are attached in the double-T-shaped profiles of the upper and lower flange. This increases the usable absorber area and also improves the visual design.

FIG. 6 shows a diagram of several measured value curves for the reverberation time over a wide frequency range. The individual curves were recorded in the same hall with a base area of 21.5 m×17.5 m and a height of 4.9 m.

Curve 1)—shown as a dash-dot line without marking—shows the course of the reverberation time in the original hall, i.e. without installing the sound absorber arrangement. The reverberation time averages 1.52 s and is therefore significantly higher than the value of 1.1 s required by DIN 18041 for speech environments (dashed line).

Curve 2)—shown as a full line with a square marking—shows the reverberation time after installation of the absorber strips according to the arrangement shown in FIG. 1 on the three roof trusses inside. The absorber strips in this case have a width of 630 mm. The reverberation time is reduced evenly across all frequencies to an average of 0.93 s.

Curve 3)—shown as a dashed line with diamond markings—shows the reverberation time in the hall if, in addition to the absorber strips on the roof trusses, further absorber strips with a width of 630 mm on the side and end walls are attached which correspond to those in the embodiment shown in FIG. 3. The acoustic absorption performance is only slightly improved by the additional installation. The reverberation time is 0.86 s.

Curve 4)—shown as a solid line with a triangle marking—shows the reverberation time in the hall again in accordance with the arrangement according to FIG. 1. Absorber strips are only on the three roof trusses on the inside. However, the width of the absorber strips was doubled to 1240 mm, while the thickness remained the same. It can be seen that a significantly reduced reverberation time of 0.66 s can be achieved in this way.

The effect that can be achieved by the sound absorber arrangement according to the invention becomes particularly clear when the absorption surfaces required are compared to the absorption surface that would be required mathematically (using Sabine's formula) if the same absorption performance is to be achieved by a closed absorption surface running parallel to the floor surface. The values are shown in the table below:

Absorber area (a=0.40) and reverberation time

| Reverberation | Absorber surface | | |
|---|---|---|---|
| time | calculation acc. to | | |
| Ø 250-4,000 Hz | Sabine formula | Built-in | |
| sec. | m² | m² % | Comment |
| 1.52 | | 0 | without acoustic |
| | | | installation |
| | | | according to DIN |
| 1.1 | 189 | | 18041 |
| 0.93 | 314 | 88 = 28 | |
| 0.86 | 379 | 137 = 36 | plus all-round |
| | | | installation |
| 0.66 | 644 | 174 = 27 | |

It is clear from the values mentioned in the table that the required absorber area can be reduced to <30% of the area calculated according to the prior art by the arrangement according to the invention.

1. Sound-absorbing roof construction of a hall with walls, several roof trusses resting at least at their ends on the walls and with a sound-reflecting roof cladding carried by the roof trusses, wherein on the side surfaces of several of the roof trusses absorber strips are attached, which are composed of sound absorber elements, wherein a sound-reflecting section of the roof cladding extends between adjacent roof trusses with the absorber strips with a width which is at least twice the average height of the roof trusses.

2. Sound-absorbing roof construction according to claim 1, wherein the absorber strips substantially completely cover the side surfaces of all roof trusses lying in the interior of the hall.

3. Sound-absorbing roof construction according to claim 1, wherein further absorber strips run along the upper edge of the walls and/or between adjacent roof trusses in the roof construction.

4. Sound-absorbing roof construction according to claim 1, further comprising an acoustically hard reflection wall is arranged between the absorber strips located opposite one another on the same roof truss which is located between the upper flange and the lower flange of the roof truss

5. Sound-absorbing roof construction according to claim 4, wherein an air gap remains between the absorber strips and the reflection wall.

6. Sound-absorbing roof construction according to claim 1, wherein the sound absorber elements of the absorber strips have a thickness of 20-65 mm, preferably 25 mm.

7. Sound-absorbing roof construction according to claim 1, wherein the sound absorber elements of the absorber strips have a length-specific flow resistance in the range 7-15 kPa*s/m⁴.

8. Sound-absorbing roof construction according to claim 1, wherein the sound absorber elements consist of a non-ductile foam, in particular a glass-based foam, which comprises expanded glass granulate.

9. Sound-absorbing roof construction according to claim 8, wherein the sound absorber elements are made of expanded glass granulate with a grain size of 0.25-4 mm, the granulate being sintered in plate form or being bonded with added binder, and the length-specific flow resistance being in the range 9-11 kPa*s/m⁴.

10. Sound-absorbing roof construction according to claim 1, wherein the roof trusses are spaced apart from one another by more than four times their mean height.

11. Sound-absorbing roof construction according to claim 1, wherein the area occupied by the absorber strips on the side faces of the roof trusses is smaller than the projected area of the roof cladding.

12. Sound-absorbing roof construction according to claim 1, wherein the roof cladding, which extends between the side surfaces of the roof trusses covered with absorber strips, is not covered with sound-absorbing material.

13. Sound absorber arrangement comprising a plurality of sound absorber elements which are arranged in a hall with walls and a roof structure which closes the hall upwards, the roof structure having a plurality of roof trusses resting on the walls and a roof cladding supported by the roof trusses, wherein absorber strips, which are composed of the sound absorber elements, are attached to the two side surfaces of several of the roof trusses, the roof cladding with absorber strips located between the roof trusses extending with a width that is more than twice the height of the absorber strips.

14. Hall with reduced reverberation time, wherein it comprises a sound-absorbing roof structure according to claim 1.
